(19) United States
(12) Patent Application Publication
(10) Pub. No.: US 2018/0286211 A1
(43) Pub. Date: Oct. 4, 2018

(54) SYSTEMS AND METHODS FOR FOREIGN OBJECT DETECTION

(71) Applicant: VeriFone, Inc., San Jose, CA (US)

(72) Inventors: Eng Joo Yap, Singapore (SG); Peng-Hoon Yong, Singapore (SG); Boon Kong Yip, Singapore (SG); John Chia Han Ngee, Singapore (SG); Yuan Fuat Chin, Singapore (SG)

(21) Appl. No.: 15/477,543

(22) Filed: Apr. 3, 2017

(51) Int. Cl. G08B 21/18; H01Q 5/335; H04B 17/23; G06Q 20/10; G06F 21/55; G01S 11/02

(52) U.S. Cl. CPC G08B 21/182; H01Q 5/335; G01S 11/02; G06Q 20/1085; G06F 21/55; H04B 17/23

(57) ABSTRACT

Systems, methods, and devices for foreign object detection are disclosed. In one embodiment, a device for detecting the presence of a foreign object in an area being monitored may include an antenna including a receive path configured to detect a sample RF signal; a RF transceiver coupled to the antenna that generates and monitors modulation and demodulation of a RF field; a memory for storing a RF reference signal; and at least one computer processor configured to receive the sample RF signal from the RF transceiver and to determine a correlation between the sample RF signal and the RF reference signal, and to determine whether the correlation is indicative of a perturbation in the RF field.

### BACKGROUND OF THE INVENTION

### 1. Field of the Invention

The present disclosure relates generally to detection devices, and more particularly to systems and methods for detection of the presence of a foreign object or device.

### 2. Description of The Related Art

It is relatively easy for intruders to place skimming devices in the vicinity of a card reader, including a smart card reader, to eavesdrop on the communication between the card and the reader because the opening where a card is inserted to a card reader is not physically secured. The skimming devices used in these attacks are often disguised as part of the device or implanted inside the reader. Being hidden from the public eye, it is possible for these devices to obtain sensitive information transmitted between a card and the card reader, such as credit card or bank account numbers, without being discovered.

These and other deficiencies exist.

### SUMMARY OF THE INVENTION

Systems, methods, and devices for foreign object detection are disclosed. In one embodiment, a device for detecting the presence of a foreign object in an area being monitored may include an antenna including a receive path configured to detect a sample RF signal; a RF transceiver coupled to the antenna that generates and monitors modulation and demodulation of a RF field; a memory for storing a RF reference signal; and at least one computer processor configured to receive the sample RF signal from the RF transceiver and to determine a correlation between the sample RF signal and the RF reference signal, and to determine whether the correlation is indicative of a perturbation in the RF field.

In one embodiment, the RF transceiver may further transmit a RF carrier signal with 100% amplitude-shift keyed modulation, frequency-shift keying modulation, phase-shift keying modulation, etc.

In one embodiment, the device may further include a matching circuit that matches an impedance of a transmitter output of the RF transceiver to that of the antenna.

In one embodiment, the controller may further generate an alert indicative of the perturbation in response to the correlation being below a threshold, a signal disabling a host device in response to the correlation being below a threshold, etc.

In one embodiment, the correlation may be based on a comparison between different time domain signals of the first signal and the reference signal.

In one embodiment, the antenna, the RF transceiver, and the at least one computer processor configured may be integrated into an unattended host device.

According to another embodiment, an information processing apparatus including at least a memory, a communication interface, and at least one computer processor, a method for detecting the presence of a foreign object in an area being monitored may include (1) transmitting a RF carrier signal; (2) receiving a sample RF signal in response to the transmission of the RF carrier signal; (3) retrieving a RF reference signal from memory; (4) comparing a RF reference signal to the sample RF signal to determine a correlation; and (5) generating an alert signal based on the correlation.

In one embodiment, the RF transceiver may further transmit a RF carrier signal with 100% amplitude-shift keyed modulation, frequency-shift keying modulation, phase-shift keying modulation, etc.

In one embodiment, the RF carrier signal may be generated using a pseudo-random bit sequence.

In one embodiment, the reference signal may be determined based on sampling a RF signal in a known environment, by loading a known RF signal, etc.

In one embodiment, the alert may be generated when the correlation is below a threshold. The alert may include a warning message, may disable a host device, etc.

In one embodiment, comparing the RF reference signal to the sample RF signal to determine the correlation may include comparing different domains and second RF signals.

These and other embodiments and advantages will become apparent from the following detailed description, taken in conjunction with the accompanying drawings, illustrating by way of example the principles of the various exemplary embodiments.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a block diagram of a system for detecting the presence of a foreign object or device according to one embodiment;

FIG. 2 depicts an exemplary implementation of the system of FIG. 1;

FIG. 3 depicts a method for detecting the presence of a foreign object or device according to one embodiment;

FIG. 4A depicts a graphical illustration of a reference signal according to one embodiment;

FIG. 4B depicts a graphical illustration of a first sample signal indicating the non-presence of an object according to one embodiment;

FIG. 4C depicts a table illustrating correlation data of the reference and first sample signals according to one embodiment;

FIG. 5A depicts a graphical illustration of a second sample signal indicating the presence of an object according to one embodiment;

FIG. 5B depicts a graphical illustration of a second sample signal indicating the non-presence of an object according to one embodiment; and

FIG. 5C depicts a table illustrating correlation data of the reference and second sample signals according to one embodiment.

### DETAILED DESCRIPTION OF PREFERRED EMBODIMENTS

The following descriptions provide different configurations and features according to exemplary embodiments. While certain nomenclature and types of applications/hardware are described, other names and application/hardware usage is possible and the nomenclature provided is done so by way of non-limiting examples only. Further, while particular embodiments are described, it should be appreciated that the features and functions of each embodiment may be combined in any manner within the capability of one of ordinary skill in the art. The figures provide additional exemplary details regarding the present invention. It should also be appreciated that these exemplary embodiments are provided as non-limiting examples only.

Various exemplary methods are provided by way of example herein. These methods are exemplary as there are a variety of ways to carry out methods according to the present disclosure. The methods depicted and described can be executed or otherwise performed by one or a combination of various systems and modules. Each block shown in the methods represents one or more processes, decisions, methods or subroutines carried out in the exemplary method, and these processes, decisions, methods or subroutines are not necessarily carried out in the specific order outlined in the methods, nor is each of them required.

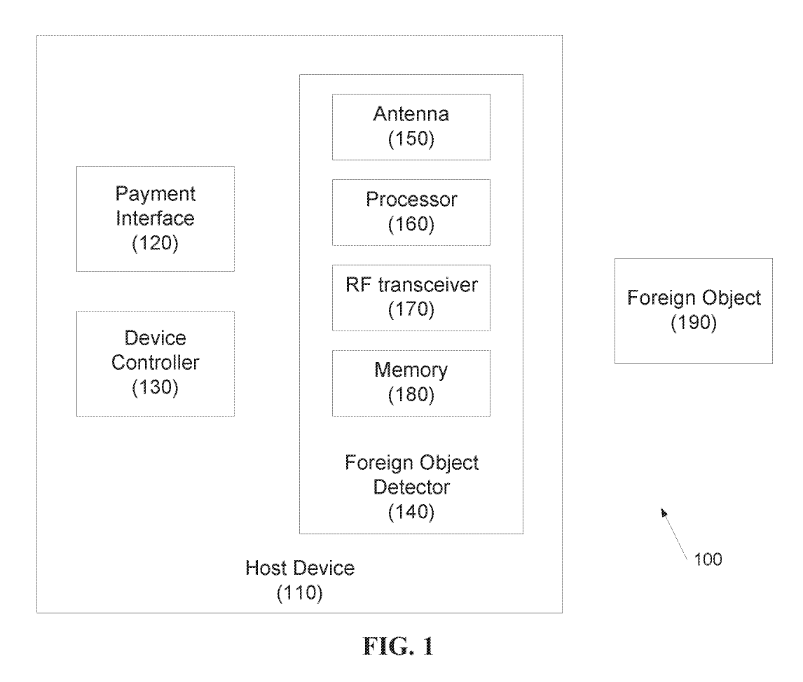

Several embodiments of the present invention and their advantages may be understood by referring to FIGS. 1-5.

Various embodiments are configured to detect device intrusion by detecting perturbations, or changes, in an RF field caused by the presence of a foreign metal-containing object that has been placed in, or near, an area being monitored with an antenna. For example, a foreign object may be an electronic card skimming device that uses near field communication (NFC) or other RF communication. The antenna may be positioned near an area being monitored, such as near a smart card connector, so as to sufficiently detect a disturbance in the RF field caused by a foreign object placed in the vicinity of the monitored area. Various embodiments disclosed herein are configured to provide the antenna near, e.g. above, below or adjacent to, the vicinity of a device where placement of a foreign object may be unwanted. For example, an antenna may be placed above a smart card connector where a skimming device might be placed to skim sensitive information being entered or communicated with the device. When a foreign object is placed near the antenna, the RF field is disturbed and the antenna is able to detect such change. A change in the RF field can be detected even if the foreign object is not connected to a power source or otherwise in a dormant state because its presence alone will cause a detectable disturbance in the RF field. An I/Q demodulator detection circuit may be used to detect a perturbation, such as a change or disturbance, of the RF field. A correlation technique on the signal from the I/Q demodulator may be used to determine if the RF field has changed, which may be used to issue an alert that a foreign object has been detected near the antenna, for example, in an area being monitored, such as an area near the smart card connector.

Referring to FIG. 1, a block diagram of a system for detecting the presence of a foreign object or device is disclosed according to one embodiment. System 100 may include host device 100, such as a point of sale (POS) device (e.g., transaction pads, gas pump transaction systems, kiosks, etc.), an ATM, or other point of transaction that may receive a payment or payment information using payment interface 120. In one embodiment, the host device may be substantially unattended during a transaction.

In one embodiment, the payment may be provided by a card (e.g., a credit card, debit card, etc.), a wireless payment token, an electronic wallet hosted by a mobile electronic device, etc. In one embodiment, the card may be a smart card, and payment interface 120 may be a smart card reader.

Host device 110 may include device controller, which may control the operation of host device 110. Host device may include other accessories and features, such as one or more display (not shown), one or more input devices (not shown), etc.

Host device may be provided with foreign object detector 140. In one embodiment, foreign object detector 140 may be an integral part of host device 110; in another embodiment, foreign object detector 140 may be provided as a separate, add-on module, device, or accessory for host device 110.

Foreign object detector 140 may include antenna 150, computer processor 160, RF transceiver 170, and memory 180. Foreign object detector 140 may communicate with device controller 130 as well as with other servers (not shown).

In one embodiment, the components of host device 110 and/or foreign object detector 140 may be implemented in a variety of ways, including as hardware components (e.g., modules), as computer executable software (e.g., on a tangible, non-transitory computer-readable medium), combinations thereof, etc.

Antenna 150 may be implemented as a high Q antenna that may be tunable. Alternatively, any suitable antenna may be used as is necessary and/or desired. Parameters that may be adjusted to meet requirements of a particular deployment include, for example, the number of loops, inductance and impedance at a certain frequency (e.g., 13.56 MHz), DC resistance, etc. In one embodiment, a matching circuit (not shown) may indirectly define the inductance, and the inductance may indirectly define the number loops and length of the antenna wires or traces. DC resistance is in the sub-zero range so that the antenna Q may be trimmed using, for example, a parallel resistor.

In one embodiment, antenna 150 may be configured to be sensitive to the presence of foreign metal-containing object 190, which may be, for example, an electronic skimming device. For example, in one embodiment, the antenna may be designed so that the RF field is narrowly focused over the area to be protected, and the antenna is tuned so that when any metallic object that is placed within the area to be protected, the perturbation of phase and magnitude of the RF wave is distinguishable. In one embodiment, antenna 150 may operate within a “close field” to minimize, reduce, or eliminate detection of foreign objects that may come near to the device being protected (e.g., payment interface 120) but are not implanted as a skimming device. By reducing the sensitivity of the antenna to the presence of such objects (e.g., by using correlation to quantify changes or differences between two temporal samples, discussed below), the detection of “false” triggers may be reduced or eliminated. For example, a false trigger may be prevented by constraining the RF field to a small volume, such as an area adjacent to payment interface 120. This may be achieved by shaping the RF field via antenna design, RF strength, and using EMI absorbers, such as ferrite sheets.

In one embodiment, antenna 150 may include at least one receive path (i.e., over at least one arm of the antenna 150) that comprises a single coil wire, insulated wire, rigid printed circuit board (PCB), flexible PCB, such as an etched on plastic, punch-out antenna. In one embodiment, antenna 150 may be positioned within 5 mm of payment interface 120, or any other device to be protected or an area to be monitored.

Computer processor 160 may be implemented as one or more microprocessors, microcontrollers, integrated circuit chips, etc. In one embodiment, processor 160 may control RF transceiver 170, and may process a correlation technique. Computer processor 160 may carry out instructions stored in memory 180. During operation, computer processor 130 may periodically capture a sample RF signal while the device is idle, that is, when the device is not performing any card transaction, and then compare the demodulated signal to a RF reference signal that may be stored in memory 180 to determine a correlation between the two signals. As will be discussed in detail below, the RF reference signal may be signal captured when it is known that no foreign objects are present.

Memory 180 may store one or more RF reference signals, which may be sampled or received when it is known that no foreign objects 190 are present (i.e., host device 110 is secure). For example, a snapshot of a RF reference signal with a known or otherwise confirmed un-compromised payment interface 120 may be stored in memory 180. In one embodiment, this RF reference signal may be obtained or determined during manufacturing (such as “arming” the detection), during initial installation, prior to deployment of the device to a user, or at any time or event when the devices may be inspected and it is verified that there are no foreign objects present. In one embodiment, the reference signal may be derived by loading a pre-determined reference signal from a library database in which such signals are stored.

In one embodiment, one or more of the RF reference signals may be updated when other received sample signals are validated with a high correlation in order to improve immunity against security breaches.

In one embodiment, memory 180 may be internal to foreign object detector 140, or it may be external to foreign object detector 140. Memory 180 may be of any type including volatile memory (such as RAM), non-volatile memory (such as ROM, flash memory, etc.), or any combination thereof. Memory 180 may be secure memory.

In one embodiment, memory 180 may include a defense mechanism that may be activated in response to an attempt to access its contents. For example, in response to such an attempt, a self-erasure process that may erase the memory content to prevent use of signature in another terminal may be activated. As another example, a process that prevents further transactions, etc. with host device 110 may be activated.

RF transceiver 170 may include one or more inputs that may be connected to antenna 150 to monitor RF field modulation over at least one receive path of antenna 150. RF transceiver 170 may be configured to generate and transmit a modulated RF carrier signal, and to receive and demodulate the sample RF signal. By way of example, and not limitation, the modulation may include digital modulation such as 100% amplitude-shift-keyed (ASK) modulation, frequency-shift keying (FSK), or phase-shift keying (PSK). RF transceiver 170 may include a transmitter (not shown) such that its output impedance is matched to that of antenna 150 in the environment in which antenna 150 is present so that the resonance is at the RF carrier frequency using a matching circuit (not shown).

In one embodiment, immunity to off-air sniffing of the RF carrier signal may be enhanced by using a pseudo-random bit sequence (“PRBS”) to change the modulated signal. This may be done periodically, randomly, or as otherwise necessary and/or desired. In one embodiment, a PRBS spectrum may include only white noise which has no obvious signature that a rogue RF sniffer can discern to determine the data used by the foreign object detector. Because a PRBS spectrum may be generated by deterministic logic elements, it is repeatable. The PRBS spectrum may be changed by using different length bits and taps positions.

In one embodiment, computer processor 160 may determine a correlation (e.g., a similarity) between the sample RF signal received by RF transceiver 170 and one or more RF reference signals that may be stored in memory 180. This correlation may be used to determine the likelihood of whether foreign object 190 is present in the area being monitored (e.g., near payment interface 120). For example, if the sample RF signal and the RF reference signal have high correlation—meaning that they are the same or substantially similar—it is unlikely that a foreign object is present in the vicinity of the device, and the integrity of the device is not compromised. If the sample RF signal and the RF reference signal have a correlation below a certain threshold—meaning that the signals differ or are not similar—it is likely that a foreign object is present in the vicinity of the device, and the integrity of the device may be compromised.

In one embodiment, when the sample RF signal and the RF reference signal have a correlation below a certain value, a merchant, an attendant, a responsible party, etc. may be informed so that cause of the low correlation can be investigated. For example, such a security warning may be based on one or more correlation thresholds, with the most significant difference or uncorrelated data resulting in a “tampering” determination. For example, signals with a correlation between 0.9 to 1 may be considered to be substantially the same and may not indicate the presence of a foreign object. Signals having a correlation between 0.7 to 0.8 may or may not indicate presence of a foreign object. For this correlation threshold, a warning may be provided without disabling the device. Signals having a correlation of between 0.6 to 0.7 may result in a severe warning, such as a warning and an instruction to investigate the source of the problem within a certain time frame. Signals having a correlation below 0.6 may result in disabling host device 110 to prevent compromises. The correlation thresholds (e.g., 0.9 to 1.0, 0.7 to 0.8, 0.6 to 0.7, and below 0.6), and the resulting action(s) taken described above are exemplary. Different correlation thresholds and ranges, the number of thresholds and ranges, and the resulting action(s) taken may be selected as is necessary and/or desired.

Computer processor 160 may communicate the alert using, for example, wired/wireless transmission to a user interface, a display, a mobile device, etc. By way of example, but not limitation, the alert may include a visual alert, an audible or sound-based alert, or a combination thereof, and the alert may be transmitted by wireless local area networks, Wi-Fi, Bluetooth, USB, etc.

In addition, in one embodiment, an automatic action may be taken in response to the correlation falling below a certain threshold. For example, when the correlation falls below a certain threshold, certain actions, such as disabling the device, erasing secure information, providing a visual message to customers that the device is inoperative, etc. may be taken. Any suitable action may be taken as is necessary and/or desired.

In exemplary embodiments, foreign object detector 140 may be provided as a module that may be added or integrated into host devices 110 that require protection from foreign objects and devices. The addition of such a module may not deplete coin cell or battery power (for portable devices) because the detection or sensing is only needed when the foreign object detector 140 is in operational mode. Any intrusion introduced during a power down condition will be detected once the system is powered up and the detection sequence is executed.

In the case of a POS terminal, some of the components (e.g., RF transceiver, ADC, CPU) may already be available as part of the terminal; thus, the cost of implementation may be lower. In addition to applicability of POS terminals, and by way of example, and without limitation, applicability may also extend to at least a subsystem of other devices such as vending machines, kiosks, automated teller machines, etc.

In one embodiment, processing and correlation may be performed locally. In another embodiment, some or all of the processing and correlation may be performed by a remote device, such as a cloud server. For example, the correlation data may be communicated to a cloud server (not shown). Depending on the correlation data, and by way of example, such commands or actions may include triggering a tamper alert action or warning, restricting the functionality of host device 110, initiating a complete shutdown of host device 110, or performing any other action as is necessary and/or desired.

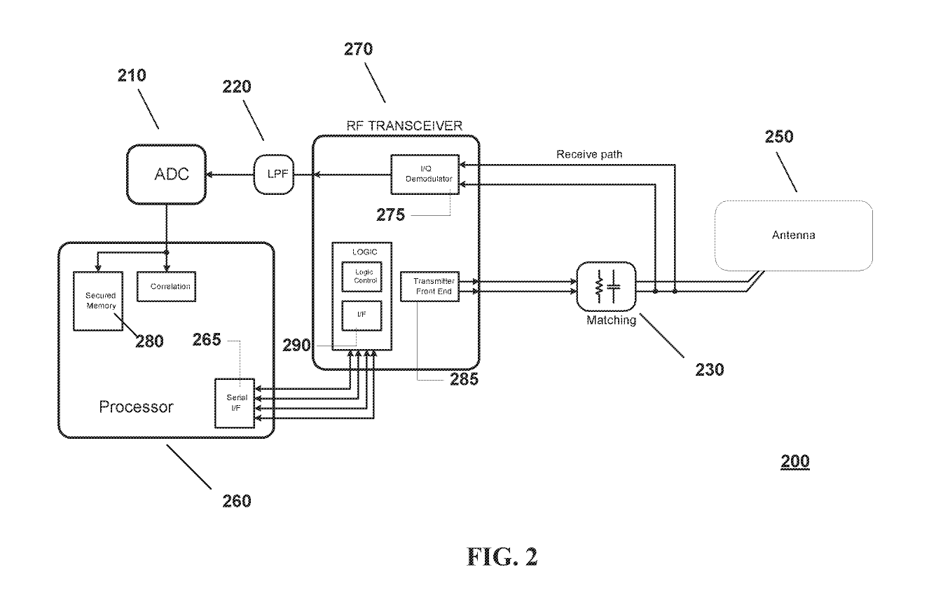

An exemplary implementation of foreign object detector 140 is provided in FIG. 2. System 200 may include antenna 250, RF transceiver 270, matching circuit 230, filter 220, ADC 210, and computer processor 260.

As illustrated in FIG. 2, RF transceiver 270 may include one or more inputs that may be connected to antenna 250 to monitor RF field modulation through a series resistor and capacitor (not shown) over the at least one receive path of antenna 250. RF transceiver 270 may be configured to generate and transmit a modulated RF signal and to receive and demodulate the received RF signal, and may include, for example, I/Q demodulator 275 to demodulate the received RF signal.

In one embodiment, I/Q demodulator 275 may include a detection circuit that may be used to detect the change or disturbance of the RF field. I/Q demodulator 275 may be internal to RF transceiver 270, or it may be external to RF transceiver 270. RF transceiver 270 may be controlled by computer processor 260 to generate and transmit a RF carrier signal coded with modulation. By way of example, and not limitation, the modulation may include digital modulation such as 100% amplitude-shift-keyed (ASK) modulation, frequency-shift keying (FSK), or phase-shift keying (PSK). RF transceiver 270 may include matching circuit 230 that matches the output impedance of transmitter 285 to that of antenna 250 in the environment in which antenna 250 is present in so that the resonance is at the RF carrier frequency. RF transceiver 270 may include interface 290 to communicate with interface 265 of computer processor 260.

Filter 220 may be configured to limit the input signal to ADC 210 to prevent anti-aliasing during digitization before being forwarded to ADC 210 for AD conversion. In one embodiment, filter 220 may be a low pass filter (“LPF”) or resistor-capacitor (“RC”) filter.

A/D converter (ADC) 210 may be configured to digitize and convert the received sample RF signal after it is demodulated by I/Q demodulator 275 and filtered by filter 220.

Computer processor 260 may include one or more integrated circuits and/or processing cores that may be configured to carry out instructions stored in memory 280. By way of example, but not limitation, memory 280 may be of any type including volatile memory (such as RAM), non-volatile memory (such as ROM, flash memory, etc.), or any combination thereof. During operation, computer processor 260 may periodically capture a sample RF signal while the device is idle, that is, when the device is not performing any card transaction, and then correlate the sample RF signal to one or more RF reference signals that may be stored in memory 280.

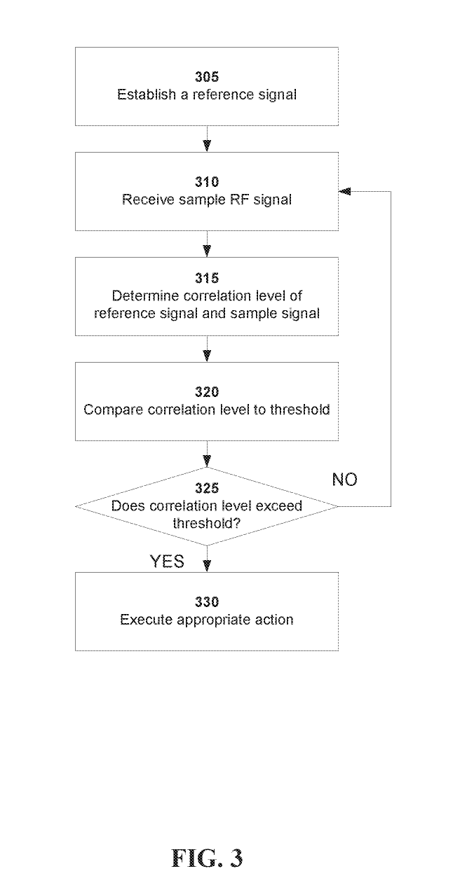

Referring to FIG. 3, an exemplary method of foreign object detection is provided according to one embodiment. In step 305, one or more reference signals may be established or obtained. In one embodiment, as discussed above, the reference signal may be stored in memory and may represent a reference signal received when it is known that no foreign objects were present in the area being monitored (e.g., a smart card reader or other interface).

In step 310, a sample RF signal may be received using the antenna. In one embodiment, as discussed above, the sample RF signal may be a demodulated signal received in response to the transmission of a modulated signal.

In step 315, a correlation between the RF reference signal and the sample RF signal may be determined. As discussed above, the correlation between the RF reference signal and the sample RF signal indicates the similarity of the two signals. A high correlation (e.g., the sample RF signal and the RF reference signal are the same or substantially similar) may indicate that no foreign objects are present in the area being monitored, while a lower correlation (e.g., the sample RF signal and the RF reference signal are dissimilar or differ by a certain amount) may indicate the likely presence of a foreign object being present.

In step 320, the correlation may be compared to at least one correlation threshold.

In step 325, if the correlation exceeds one of the thresholds, in step 330, an appropriate action may be taken, such as generating an alert, disabling the host device, etc.

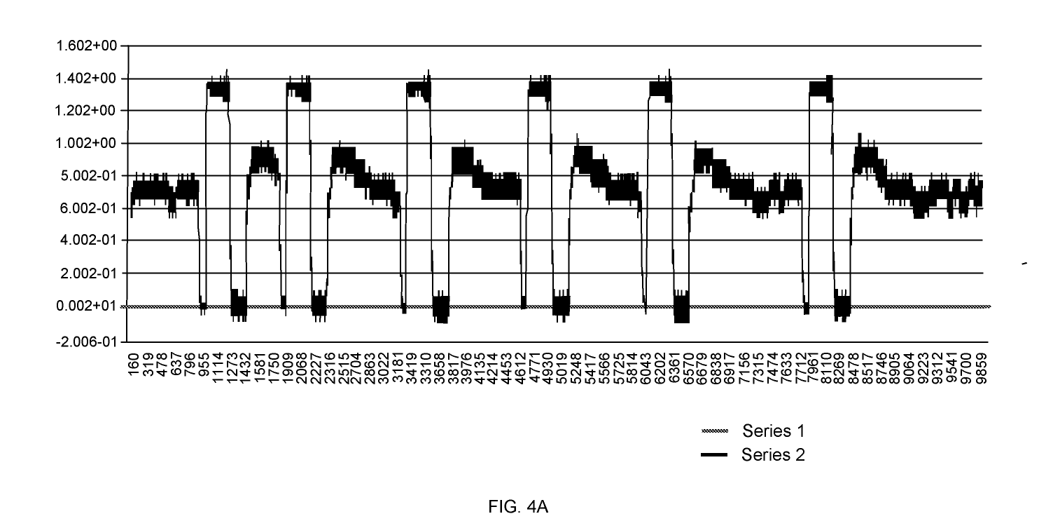

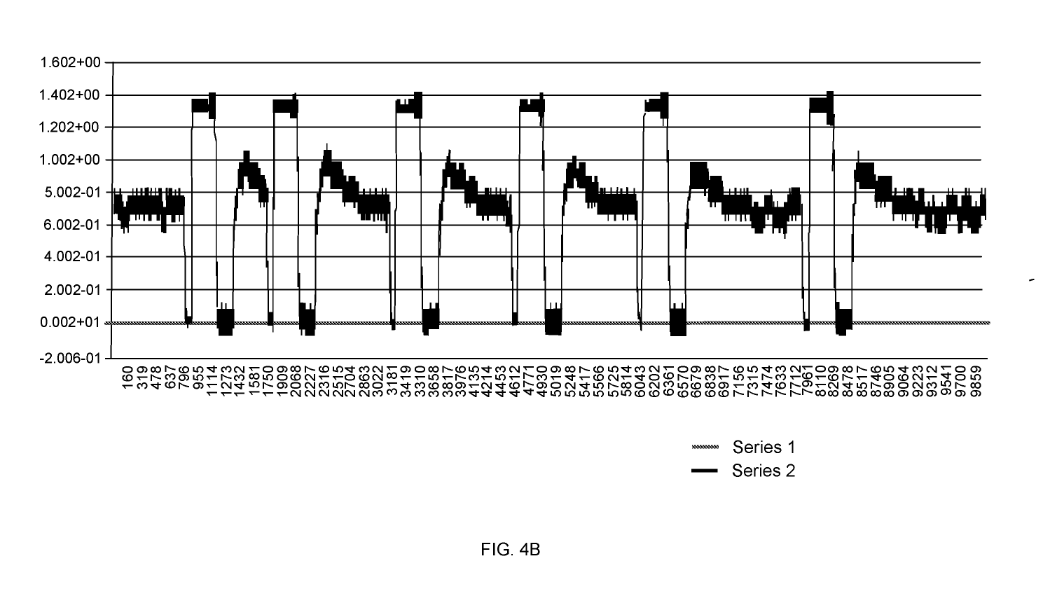

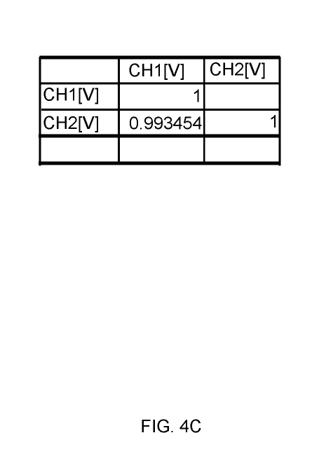

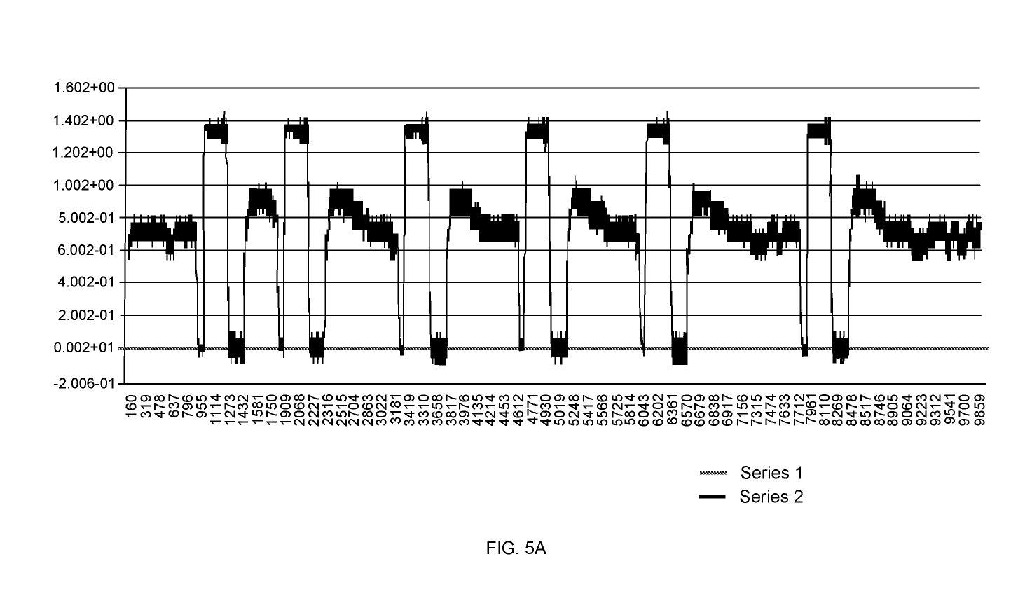

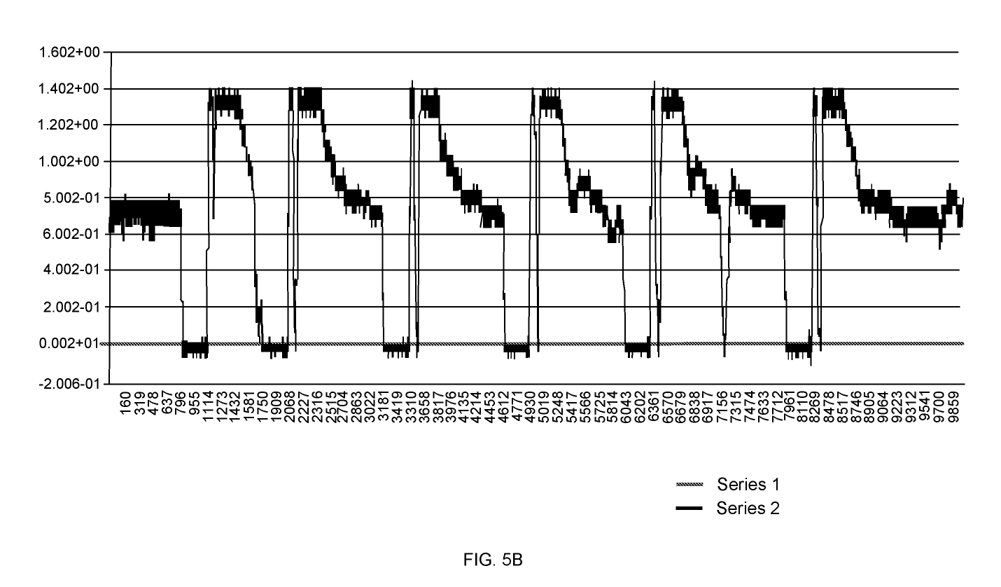

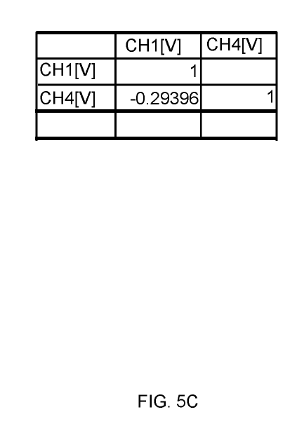

Exemplary illustrations of reference signal, sample signal, and their correlations are provided in FIGS. 4 and 5. Referring to FIGS. 4A and 4B, graphical illustrations of a reference signal and a first sample signal are provided, respectively. FIG. 4C depicts the correlation between the RF reference signal and the first sample RF signal. For example, CH1[V] and CH2[V] indicate the voltage level of the RF reference signal and the first sample RF signal, respectively, over time. FIG. 4C depicts a high correlation, indicating that the RF reference signal and the first sample RF signal are substantially similar, and that there are no foreign objects present in the area being monitored.

Referring to FIGS. 5A and 5B, graphical illustrations of a RF reference signal and a second sample RF signal are provided, respectively. FIG. 5C depicts the correlation between the RF reference signal and the second sample RF signal. FIG. 5C depicts a low correlation between the RF reference signal and second sample RF signal. This indicates the likely presence of a foreign object in the area being monitored. In response, the system may cause an alert to be sent so that action can be taken by an attendant, such as inspecting the device, or it may take the device offline so that it cannot be used until the device has been inspected and/or cleared (e.g., any foreign objects removed).

It will be appreciated by those skilled in the art that the various embodiments are not limited by what has been particularly shown and described hereinabove. Rather the scope of the various embodiments includes both combinations and sub-combinations of features described hereinabove and variations and modifications thereof which are not in the prior art. It should further be recognized that these various embodiments are not exclusive to each other.

It will be readily understood by those persons skilled in the art that the embodiments disclosed here are susceptible to broad utility and application. Many embodiments and adaptations other than those herein described, as well as many variations, modifications and equivalent arrangements, will be apparent from or reasonably suggested by the various embodiments and foregoing description thereof, without departing from the substance or scope of the above description.

Accordingly, while the various embodiments have been described here in detail in relation to exemplary embodiments, it is to be understood that this disclosure is only illustrative and exemplary and is made to provide an enabling disclosure. Accordingly, the foregoing disclosure is not intended to be construed or to limit the various embodiments or otherwise to exclude any other such embodiments, adaptations, variations, modifications or equivalent arrangements.

1. A device for detecting the presence of a foreign object in an area being monitored, comprising:
an antenna including a receive path configured to detect a sample RF signal;
a RF transceiver coupled to the antenna that generates and monitors modulation and demodulation of a RF field;
a memory for storing a RF reference signal; and
at least one computer processor configured to receive the sample RF signal from the RF transceiver and to determine a correlation between the sample RF signal and the RF reference signal, and to determine whether the correlation is indicative of a perturbation in the RF field.

2. The device of claim 1, wherein the RF transceiver further transmits a RF carrier signal with 100% amplitude-shift keyed modulation.

3. The device of claim 1, wherein the RF transceiver further transmits a RF carrier signal with frequency-shift keying modulation.

4. The device of claim 1, wherein the RF transceiver further transmits a RF carrier signal with phase-shift keying modulation.

5. The device of claim 1 further comprising:
a matching circuit that matches an impedance of a transmitter output of the RF transceiver to that of the antenna.

6. The device of claim 1, wherein the controller further generates an alert indicative of the perturbation in response to the correlation being below a threshold.

7. The device of claim 1, wherein the controller generates a signal disabling a host device in response to the correlation being below a threshold.

8. The device of claim 1, wherein the correlation is based on a comparison between different time domain signals of the sample RF signal and the RF reference signal.

9. The device of claim 1, wherein the antenna, the RF transceiver, and the at least one computer processor configured are integrated into an unattended host device.

10. A method for detecting the presence of a foreign object in an area being monitored, comprising:
an information processing apparatus including at least a memory, a communication interface, and at least one computer processor:
transmitting a RF carrier signal;
receiving a sample RF signal in response to the transmission of the RF carrier signal;
retrieving a RF reference signal from memory;
comparing a RF reference signal to the sample RF signal to determine a correlation;
generating an alert signal based on the correlation.

11. The method of claim 10, wherein the RF carrier signal comprises 100% amplitude-shift keyed modulation.

12. The method of claim 10, wherein the RF carrier signal comprises frequency-shift keying modulation.

13. The method of claim 10, wherein the RF carrier signal comprises phase-shift keying modulation.

14. The method of claim 10, wherein the RF carrier signal is generated using a pseudo-random bit sequence.

15. The method of claim 10, wherein the reference signal is determined based on sampling a RF signal in a known environment.

16. The method of claim 10, wherein the reference signal is determined by loading a known RF signal.

17. The method of claim 10, wherein the alert is generated when the correlation is below a threshold.

18. The method of claim 10, wherein the alert comprises a warning message.

19. The method of claim 10, wherein the alert disables a host device.

20. The method of claim 10, wherein the step of comparing the RF reference signal to the sample RF signal to determine the correlation comprises comparing different domains and second RF signals.
